(19) United States
(12) Patent Application Publication
(10) Pub. No.: US 2016/0381020 A1
(43) Pub. Date: Dec. 29, 2016

(54) COMBINED KEY SECURITY

(71) Applicant: International Business Machines Corporation, Armonk, NY (US)

(72) Inventors: John E. Moore, JR., Brownsburg, IN (US); Jeffrey K. Price, Austin, TX (US); Robert R. Wentworth, Round Rock, TX (US); Stanley C. Wood, Round Rock, TX (US)

(21) Appl. No.: 14/746,915

(22) Filed: Jun. 23, 2015

(51) Int. Cl. H04L 29/06

(52) U.S. Cl. CPC H04L 63/10

(57) ABSTRACT

Embodiments of the present invention disclose a method, system, and computer program product for a combined key security program. A computer receives an access request from a resource (or a device associated with the resource) which includes a combined key detailing factors corresponding to users and resources involved in the request. The computer references an access policy of the resource to which access is requested and determines whether the access policy requires state keys necessary to indicate a time, place, or other current state information. If a state key is necessary, the computer retrieves the required state key and adds it to the combined key. The computer then determines whether the combined key satisfies the referenced access policy, and if so, grants the access request, else the access request is denied.

### TECHNICAL FIELD

The present invention relates generally to securing resources, and more particularly to evaluating multiple factors combined into a single access key against security access policies.

### BACKGROUND

Security systems are widely used around the world. Current security systems utilize measures such as keys (electronic or physical), access codes, login credentials, and physical characteristics such as retina or fingerprint scans. While these methods prove sufficient for many applications, each of the aforementioned methods requires separate keys which are evaluated independently, whether they are physical, electronic, or user input.

### SUMMARY

Embodiments of the present invention disclose a method, system, and computer program product for a combined key security program. A computer receives an access request from a resource (or a device associated with the resource) which includes a combined key detailing factors corresponding to users and resources involved in the request. The computer references an access policy of the resource to which access is requested and determines whether the access policy requires state keys necessary to indicate a time, place, or other current state information. If a state key is necessary, the computer retrieves the required state key and adds it to the combined key. The computer then determines whether the combined key satisfies the referenced access policy, and if so, grants the access request, else the access request is denied.

### BRIEF DESCRIPTION OF THE SEVERAL VIEWS OF THE DRAWING

FIG. 1 illustrates a combined key security system, in accordance with an embodiment of the invention.

FIG. 2 is a flowchart illustrating the operations of the combined key security system of FIG. 1 in determining access based on a combined key and access policies stored on a centralized server, in accordance with an embodiment of the invention.

FIG. 3 is a block diagram depicting the hardware components of a combined security system of FIG. 1, in accordance with an embodiment of the invention.

### DETAILED DESCRIPTION

Embodiments of the present invention will now be described in detail with reference to the accompanying figures.

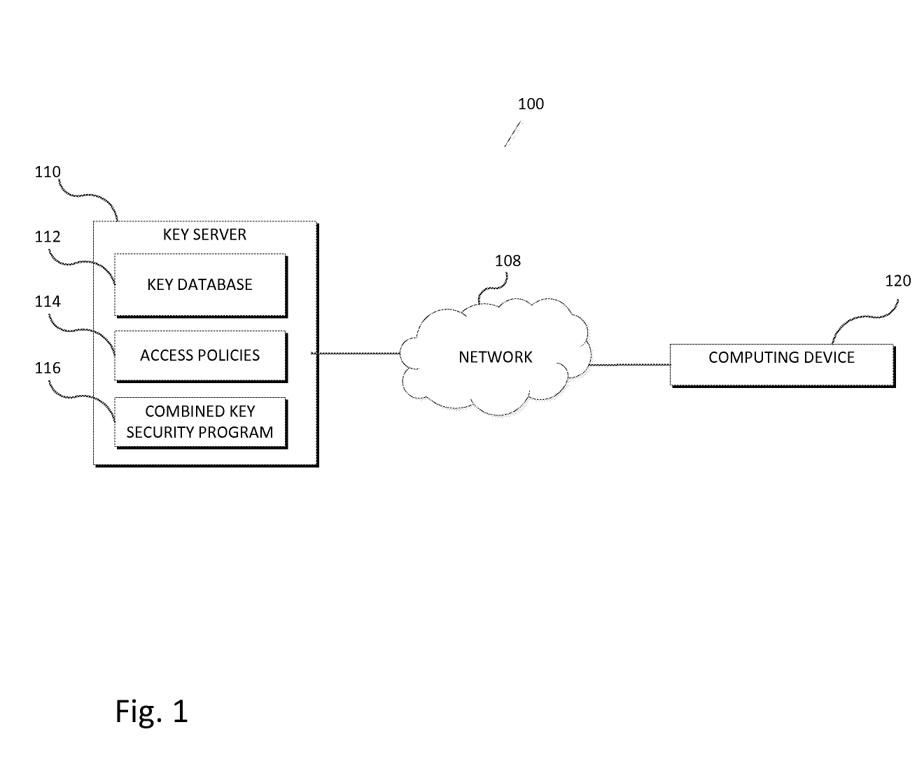

FIG. 1 illustrates a combined key security system 100, in accordance with an embodiment of the invention. In the example embodiment, combined key security system 100 includes key server 110, network 108, and computing device 120.

In the example embodiment, network 108 may be the Internet, representing a worldwide collection of networks and gateways to support communications between devices connected to the Internet. Network 108 may include, for example, wired, wireless or fiber optic connections. In other embodiments, network 108 may be implemented as an intranet, a local area network (LAN), or a wide area network (WAN). In general, network 108 can be any combination of connections and protocols that will support communications between key server 110 and computing device 120.

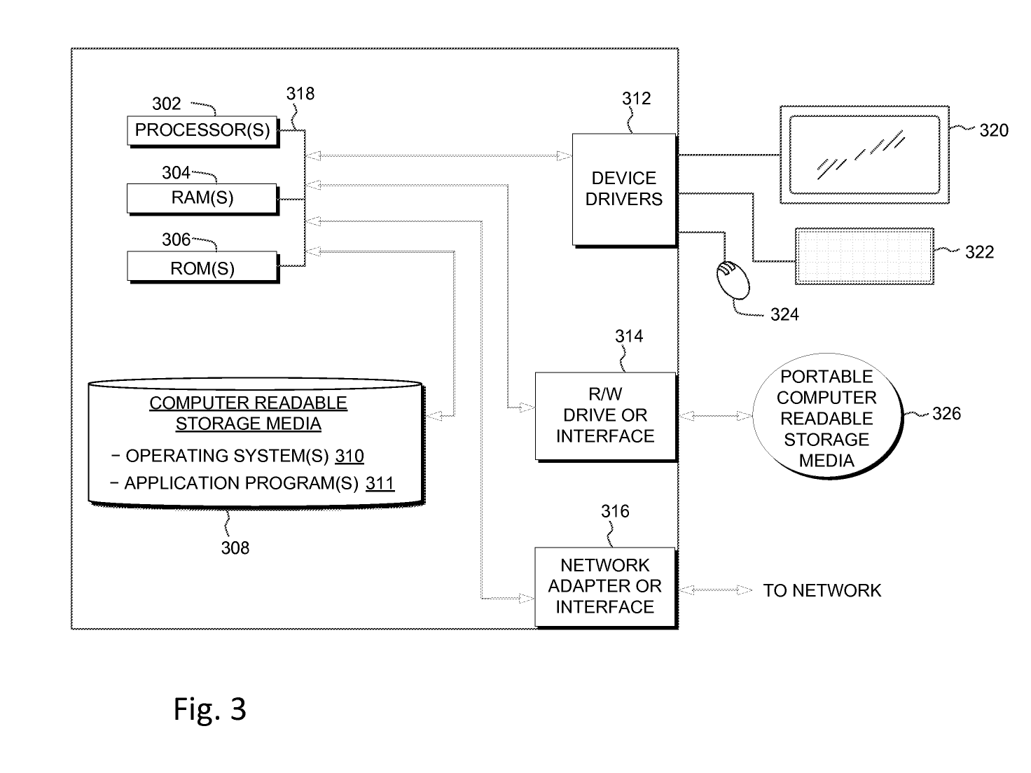

Computing device 120 may be a laptop computer, a notebook, tablet computer, netbook computer, personal computer (PC), a desktop computer, a personal digital assistant (PDA), a smart phone, a thin client, or any other electronic device or computing system capable of receiving and sending data to and from other computing devices. In the example embodiment, computing device 120 is one of the resources to which access is being requested and is capable of merging its own resource key with the user key(s) of individual user(s) before transmitting the combined key to key server 110. While computing device 120 is shown as a single device, in other embodiments, computing device 120 may be comprised of a cluster or plurality of computing devices, working together or working separately. Computing device 120 is described in more detail with reference to FIG. 3.

Key server 110 includes key database 112, access policies 114, and combined key security program 116. In the example embodiment, key server 110 may be a laptop computer, a notebook, tablet computer, netbook computer, personal computer (PC), a desktop computer, a personal digital assistant (PDA), a smart phone, a thin client, or any other electronic device or computing system capable of receiving and sending data to and from other computing devices. While key server 110 is shown as a single device, in other embodiments, key server 110 may be comprised of a cluster or plurality of computing devices, working together or working separately. Key server 110 is described in more detail with reference to FIG. 3.

Key database 112 is an organized collection of data detailing the factors necessary for permitting access to a resource secured by combined key security program 116. In the example embodiment, key holders are cryptographic keys consisting of series of numbers and are a representation of one or more factors taken into consideration by combined key security program 116 in determining whether access to a resource is permitted. Key holders include user keys representing the individuals registered in combined key security program 116, resource keys representing the resources secured by combined key security program 116, and state keys representing the current state at the time access to a resource is requested. User keys correspond to the identity of the individual(s) requesting access. Resource keys correspond to the secured resource and include device keys (such as the resource key corresponding to computing device 120), campus keys, building keys, room keys, network keys, document keys, printer keys, and any other resources secured by combined key security program 116. State keys represent information of the current state of the access request in order to confirm factors such as the time, date, and location a request is made to a time/date/location restricted resource. State keys may represent factors such as pressure, temperature, elevation, humidity, noise, light, weather, proximity, and other factors detailing a current environment or state. Each key holder in key database 112 corresponds to factors utilized by combined key security program 116 in determining the whether access to a resource is permitted, including factors such as what, who, where, and when. Key holders of the resource(s) and user(s) are combined by the security software on or associated with the requested resource when the request is made, for example a badge entry associated with a resource (computer). The combined key, comprising the user key and resource key, is then transmitted to combined key security program 116 to determine if the combined key, evaluated in aggregate, contain the factors necessary to satisfy the access policies detailed in access policies 114. Key holders can be thought of as puzzle pieces that, when combined with all the necessary factors, fit the puzzle enumerated in access policies 114. Thus, a single resource key, such as the resource key of computing device 120, may be combined with the user keys of hundreds of individuals requesting access to computing device 120 (access policies are described in more detail with reference to step 208). In the example embodiment, key holders and information associated with each key holder are added electronically to key database 112 via a user input on key server 110. Furthermore, in the example embodiment, the tangible user keys corresponding to the electronic keys in key database 112 are input into computing device 120 by way of RFID tags (Radio Frequency Identification) while resource keys are electronically and/or physically embedded into the hardware/software of the resource or device containing the resource. In other embodiments, however, a user may input their user key with passcodes, login credentials, or other identification means such as retina or thumbprint scanning.

Access policies 114 is an organized collection of data which details the policies for permitting access to resources secured by combined key security program 116. Access policies 114 details factors that need be present in the combined key for access to each resource secured by combined key security program 116, those factors including user ID, time, date, location, presence or absence of additional users/resources, state of access doors/gates, environmental conditions, and the requested resource. For example, the policies may be as simple as permitting a user access to a device when the resource key of the device is combined with the valid user key. In more complex examples, user access to the device may only be permitted when the valid user key is combined with the device resource key and the state key of a particular location. Alternatively, user access to the device may only be permitted when the device resource key is combined with multiple and specific user keys. In another example, user access to the device may only be permitted when the valid user key is combined with the device resource key and a state key at a particular time. In the example embodiment, each resource access policy may be as stringent or relaxed as desired and may be entered/adjusted via user input on key server 110 locally or remotely, enabling flexibility and customization of access to resources secured by combined key security program 116.

Combined key security program 116 is a program capable of receiving key holders, such as the user, resource, and state keys stored in key database 112, and retrieving the access policy of a resource, such as the access policies stored in access policies 114. Combined key security program 116 is further capable of determining whether additional keys are necessary to access the resource, and, if so, requesting the necessary keys. Combined key security program 116 is additionally capable of determining whether access should be permitted to a resource based on security policies and the information represented by key holders. In the example embodiment, combined key security program 116 is stored locally on key server 110, however, in other embodiments, combined key security program 116 may be stored remotely and accessed via a network such as network 108.

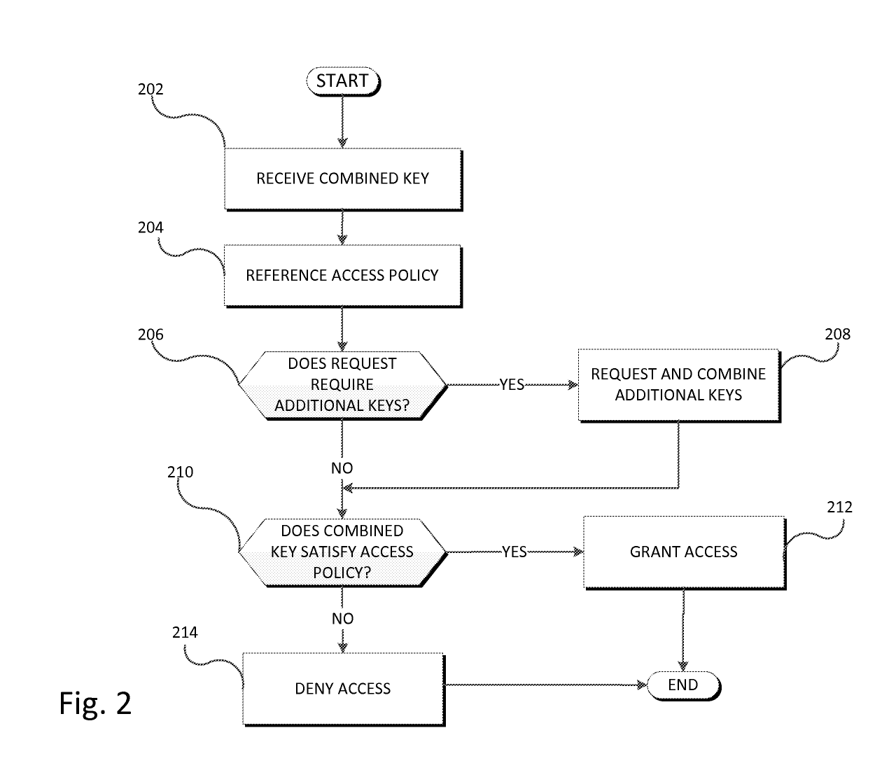

FIG. 2 is a flowchart depicting the operations of combined key security program 116 in determining whether access to a resource should be granted based on the combined key and relevant access policies. Combined key security program 116 receives the combined key from the resource to which access is requested (step 202). In the example embodiment where combined key security program 116 is stored on key server 110 and the resource to which access is requested is computing device 120, combined key security program 116 receives the combined key from computing device 120 remotely via network 108. In other embodiments, however, combined key security program 116 may receive the combined key from other resources to which access is being requested locally. The received combined key includes the user keys of any users requesting access to a resource as well as the resource keys of any resources to which access is being requested. In the example embodiment, user keys are input into the desired resource utilizing RFID tags in which electromagnetic fields are used to wirelessly transfer data for the purpose of identifying and tracking tags attached to objects. However, in other embodiments, user keys may be presented with access credentials, passcodes, retina scan, fingerprint scan, or other unique individual identifier. For example, user Alpha may present their corresponding user key to a resource, Computer 1, by scanning a badge which includes an RFID tag at Computer 1 or by entering a username and password combination at Computer 1. In the example embodiment, resource keys are embedded into the hardware and/or software of the resource (or device on which the resource is stored), however in other embodiments, resource keys may be stored remotely. For example, the resource key of a shared computer, Computer 1, may be embedded within the security software of Computer 1 such that the resource key of Computer 1 can be combined with any user keys requesting access to Computer 1. In the example embodiment, a user requests access to a resource by scanning an RFID tag corresponding to that user at the resource to which access is requested. The resource then combines the received user key with the resource key of the resource and transmits the combined key to combined key security program 116 on server 110 for evaluation. For example, if authorized student Alpha is requesting access to shared campus computer, Computer 1, which any authorized student can access between the hours of 9:00 AM and 5:00 PM, then Computer 1 combines the user key specific to student Alpha and the resource key corresponding to Computer 1 and transmits the combined key to combined key security program 116.

Combined key security program 116 references the access policy corresponding to the resource to which access is requested by consulting access policies 114 on server 110 (step 204). Access policies 114 details the factors that must be presented by the combined key in order to allow access to a resource. In the example embodiment, the access policies of a resource are stored locally on server 110, however in other embodiments, combined key security program 116 may retrieve the access policies from another computing device via network 108.

Combined key security program 116 determines whether additional state keys are required to access a resource by referencing the access policies of the resource from access policies 114 (decision 206). While some access policies may be satisfied with a combined key consisting of a user and resource key, other access policies require additional factors for authentication, such as state keys indicating a time, date, or location. Combined key security program 116 determines whether additional state keys are necessary for authentication by referencing access policies 114 in order to determine whether factors such as time, date, and location are conditional for access to a resource. State key requirements may be created and edited by an administrator of the security system locally on key server 110 or remotely via network 108. State key requirements are customizable and may, for example, be necessary for access to certain resources in general, or necessary for access to certain resources for particular user keys. Using the example above of student Alpha who is permitted access to Computer 1 from 9:00 AM to 5:00 PM, if student Alpha requests access Computer 1 at 10:00 AM, then combined key security program 116 references the access policy of Computer 1 and determines that a state key indicating a time between 9:00 AM and 5:00 PM is necessary for access.

If the resource requires additional keys (decision 206 “YES” branch), then combined key security program 116 requests the state keys necessary to evaluate the request in accordance with access policies 114 (step 208). Combined key security program 116 requests the necessary state keys by retrieving the state keys from the resource responsible for providing trustworthy source of current states, such as an atomic clock for time. Continuing the example above, if student Alpha attempts to access Computer 1 at 10:00 AM, then combined key security program 116 retrieves and combines into the combined key the state key of a trusted time source.

If additional key holders are not necessary to evaluate the request (decision 206 “NO” branch), then combined key security program 116 determines whether the combined key provided by computing device 120 satisfies the access policies detailed in access policies 114 (decision 210). Combined key security system determines whether access to a resource is permitted by comparing the factors presented in the combined key with the factors necessary for access to the resource as detailed in access policies 114. In the example embodiment, the combined key, including any state factors, is received by combined key security program 116 as an encrypted value which is compared to an Access Control List (ACL) containing a list of approved, encrypted combined key values. In other embodiments, however, combined key security program 116 may decrypt the received combined key before comparing it to an ACL. In further embodiments, combine key security program 116 may break down the received combined key into individual factors and then compare the encrypted or decrypted factors to ACLs. Factors considered in permitting access include user ID, time, date, location, resource, and any other factors dictating access. Continuing the example above with authorized student Alpha requesting access to Computer 1 where Computer 1 is only accessible to authorized students between the hours of 9:00 AM and 5:00 PM, if student Alpha requests access to Computer 1 at 10:00 AM, then student Alpha will be permitted access to Computer 1 because Student Alpha meets the access policy of Computer 1. The access policy of Computer 1 permits access to authorized students at authorized times and, in the current example, Student Alpha is both authorized and has requested access at an authorized time. Conversely, if Alpha requests access to Computer 1 at 5:01 PM, combined key security program will deny Student Alpha access to the resource because although student Alpha is an authorized user of Computer 1, student Alpha is lacking the valid state key necessary to gain access to the resource. While state keys may be necessary for some users, they may not be necessary for others based on access policies 114. For example, if the access policy of Computer 1 does not require a state key for teacher access, then teacher Charlie would be granted access to Computer 1 at any time of day.

If the combined key provided by computing device 120 satisfies the access policy detailed in access policies 114 of the resource (decision 210 “YES” branch), then combined key security program 116 allows access to the resource (step 212).

If the combined key provided by computing device 120 does not satisfy the access policy detailed in access policies 114 of the resource (decision 210 “NO” branch), then combined key security program 116 denies access to the resource (step 214).

FIG. 3 depicts a block diagram of components of key server 110 of a combined key security system 100 of FIG. 1, in accordance with an embodiment of the present invention. It should be appreciated that FIG. 3 provides only an illustration of one implementation and does not imply any limitations with regard to the environments in which different embodiments may be implemented. Many modifications to the depicted environment may be made.

Key server 110 may include one or more processors 302, one or more computer-readable RAMs 304, one or more computer-readable ROMs 306, one or more computer readable storage media 308, device drivers 312, read/write drive or interface 314, network adapter or interface 316, all interconnected over a communications fabric 318. Communications fabric 318 may be implemented with any architecture designed for passing data and/or control information between processors (such as microprocessors, communications and network processors, etc.), system memory, peripheral devices, and any other hardware components within a system.

One or more operating systems 310, and one or more application programs 311, for example, combined key security program 116, are stored on one or more of the computer readable storage media 308 for execution by one or more of the processors 302 via one or more of the respective RAMs 304 (which typically include cache memory). In the illustrated embodiment, each of the computer readable storage media 308 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Key server 110 may also include a R/W drive or interface 314 to read from and write to one or more portable computer readable storage media 326. Application programs 311 on key server 110 may be stored on one or more of the portable computer readable storage media 326, read via the respective R/W drive or interface 314 and loaded into the respective computer readable storage media 308.

Key server 110 may also include a network adapter or interface 316, such as a TCP/IP adapter card or wireless communication adapter (such as a 4G wireless communication adapter using OFDMA technology). Application programs 311 on key server 110 may be downloaded to the computing device from an external computer or external storage device via a network (for example, the Internet, a local area network or other wide area network or wireless network) and network adapter or interface 316. From the network adapter or interface 316, the programs may be loaded onto computer readable storage media 308. The network may comprise copper wires, optical fibers, wireless transmission, routers, firewalls, switches, gateway computers and/or edge servers.

Key server 110 may also include a display screen 320, a keyboard or keypad 322, and a computer mouse or touchpad 324. Device drivers 312 interface to display screen 320 for imaging, to keyboard or keypad 322, to computer mouse or touchpad 324, and/or to display screen 320 for pressure sensing of alphanumeric character entry and user selections. The device drivers 312, R/W drive or interface 314 and network adapter or interface 316 may comprise hardware and software (stored on computer readable storage media 308 and/or ROM 306).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and computer program product have been disclosed. However, numerous modifications and substitutions can be made without deviating from the scope of the present invention. Therefore, the present invention has been disclosed by way of example and not limitation.

Various embodiments of the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for combined key security, the method comprising:
receiving a request for access to a first resource, wherein the request includes a combined key, and wherein the combined key included in the request includes one or more user keys and one or more resource keys; and
determining whether the combined key included in the request satisfies an access policy of the first resource,
wherein one or more steps of the above method are performed using one or more computers.

2. The method of claim 1, further comprising:
determining whether the access policy requires one or more state keys, wherein the one or more state keys include information detailing a current state of the request; and
based on determining that the access policy requires one or more state keys, retrieving the required one or more state keys and adding the required one or more state keys to the combined key included in the request.

3. The method of claim 2, wherein each of the one or more state keys details a time, a date, a location, or other information, respectively, regarding the current state of the request for access to the first resource.

4. The method of claim 1, wherein determining whether the combined key included in the request satisfies the access policy of the first resource further comprises comparing the combined key included in the request with one or more combined keys detailed in the access policy.

5. The method of claim 1, wherein determining whether the combined key included in the request satisfies the access policy of the first resource further comprises determining one or more factors associated with the combined key included in the request and comparing the one or more factors associated with the combined key included in the request with one or more factors detailed in the access policy.

6. The method of claim 1, further comprising:
based on determining that the combined key included in the request does not satisfy the access policy of the first resource, denying access to the first resource.

7. The method of claim 1, further comprising:
based on determining that the combined key included in the request does satisfy the access policy of the first resource, granting access to the first resource.

8. A computer program product for a combined key security program, the computer program product comprising:
one or more computer-readable storage media and program instructions stored on the one or more computer-readable storage media, the program instructions comprising:
program instructions to receive a request for access to a first resource, wherein the request includes a combined key, and wherein the combined key included in the request includes one or more user keys and one or more resource keys;
program instructions to determine whether the combined key included in the request satisfies an access policy of the first resource;
based on determining that the combined key included in the request does not satisfy the access policy of the first resource, program instructions to deny access to the first resource; and
based on determining that the combined key included in the request does satisfy the access policy of the first resource, program instructions to grant access to the first resource.

9. The computer program product of claim 8, further comprising:
program instructions to determine whether the access policy requires one or more state keys, wherein the one or more state keys include information detailing a current state of the request; and
based on determining that the access policy requires one or more state keys, program instructions to retrieve the required one or more state keys and adding the required one or more state keys to the combined key included in the request.

10. The computer program product of claim 9, wherein each of the one or more state keys details a time, a date, a location, or other information, respectively, regarding the current state of the request for access to the first resource.

11. The computer program product of claim 8, wherein determining whether the combined key included in the request satisfies the access policy of the first resource further comprises comparing the combined key included in the request with one or more combined keys detailed in the access policy.

12. The computer program product of claim 8, wherein determining whether the combined key included in the request satisfies the access policy of the first resource further comprises determining one or more factors associated with the combined key included in the request and comparing the one or more factors associated with the combined key included in the request with one or more factors detailed in the access policy.

13. The computer program product of claim 8, wherein the first resource is a device, a document, a room, a network, a door, a campus, or other secured resource.

14. The computer program product of claim 8, wherein the access policy, the one or more resource keys, and the one or more user keys are configured via user input.

15. A computer system for a combined key security program, the computer system comprising:
one or more computer processors, one or more computer-readable storage media, and program instructions stored on one or more of the computer-readable storage media for execution by at least one of the one or more processors, the program instructions comprising:
program instructions to receive a request for access to a first resource, wherein the request includes a combined key, and wherein the combined key included in the request includes one or more user keys and one or more resource keys;
program instructions to determine whether the combined key included in the request satisfies an access policy of the first resource;
based on determining that the combined key included in the request does not satisfy the access policy of the first resource, program instructions to deny access to the first resource; and
based on determining that the combined key included in the request does satisfy the access policy of the first resource, program instructions to grant access to the first resource.

16. The computer system of claim 15, further comprising:
program instructions to determine whether the access policy requires one or more state keys, wherein the one or more state keys include information detailing a current state of the request; and
based on determining that the access policy requires one or more state keys, program instructions to retrieve the required one or more state keys and adding the required one or more state keys to the combined key included in the request.

17. The computer system of claim 16, wherein each of the one or more state keys details a time, a date, a location, or other information, respectively, regarding the current state of the request for access to the first resource.

18. The computer system of claim 15, wherein determining whether the combined key included in the request satisfies the access policy of the first resource further comprises comparing the combined key included in the request with one or more combined keys detailed in the access policy.

19. The computer system of claim 15, wherein determining whether the combined key included in the request satisfies the access policy of the first resource further comprises determining one or more factors associated with the combined key included in the request and comparing the one or more factors associated with the combined key included in the request with one or more factors detailed in the access policy.

20. The computer system of claim 15, wherein the first resource is a device, a document, a room, a network, a door, a campus, or other secured resource.
